(19) United States
(12) Patent Application Publication
(10) Pub. No.: US 2026/0320472 A1
(43) Pub. Date: Oct. 15, 2026

(54) GENERATING DIGITAL COMPONENTS USING CUSTOMIZED MACHINE LEARNING MODELS

(71) Applicant: Google LLC, Mountain View, CA (US)

(72) Inventors: Xiaohang Li, Cupertino, CA (US); Feng Yang, Sunnyvale, CA (US)

(21) Appl. No.: 18/861,480

(22) PCT Filed: Nov. 21, 2023
(86) PCT No.: PCT/US2023/080748

§ 371 Date: Oct. 29, 2024

(51) Int. Cl. G06N 20/00

(52) U.S. Cl. CPC G06N 20/00

(57) ABSTRACT

One example method includes obtaining, by an artificial intelligence (AI) system, first model parameters of a first machine learning model; generating a second machine learning model based on the first model parameters, the second machine learning model being at a given hierarchical layer of a hierarchical model structure; refining the second machine learning model to obtain an updated second machine learning model comprising second model parameters, wherein the first model parameters and the second model parameters have a different value for at least one model parameter; and generating, by the AI system, a third machine learning model based on the second model parameters, wherein (i) the third machine learning model is at a lower hierarchical layer of the hierarchical model structure beneath the given hierarchical layer of the second machine learning model, and (ii) the second machine learning model and the third machine learning model have a first common attribute.

### BACKGROUND

This specification relates to data processing and generating digital components using customized machine learning models.

Advances in machine learning are enabling artificial intelligence to be implemented in more applications. For example, a generative model is a type of machine learning model that aims to learn and mimic the underlying distribution of a given dataset. Unlike discriminative models that focus on classifying data into predefined categories, generative models are designed to generate new data that resembles the original training data. Generative models are used in various applications, such as image generation, text synthesis, and data augmentation.

### SUMMARY

In general, one innovative aspect of the subject matter described in this specification can be embodied in methods that include the actions of obtaining, by an artificial intelligence (AI) system, first model parameters of a first machine learning model; generating, by the AI system, a second machine learning model based on the first model parameters, the second machine learning model being at a given hierarchical layer of a hierarchical model structure; refining, by the AI system, the second machine learning model to obtain an updated second machine learning model comprising second model parameters, wherein the first model parameters and the second model parameters have a different value for at least one model parameter; and generating, by the AI system, a third machine learning model based on the second model parameters, wherein (i) the third machine learning model is at a lower hierarchical layer of the hierarchical model structure beneath the given hierarchical layer of the second machine learning model, and (ii) the second machine learning model and the third machine learning model have a first common attribute.

These and other embodiments can each optionally include one or more of the following features. The first common attribute can include at least one of a common vertical market or a common geographical region.

The second model parameters can be unshareable with the first machine learning model.

Methods can include refining, by the AI system, the third machine learning model to obtain an updated third machine learning model including third model parameters, where the third model parameters and the second model parameters can have at least one different model parameter, and the third model parameters can be unshareable with the second machine learning model.

The first machine learning model can be a root of a tree of machine learning models, the first machine learning model can have one or more machine learning models as one or more child nodes of the first machine learning model, and each child node of the first machine learning model can be a root of a sub-tree, where a first sub-tree of machine learning models can include the second machine learning model being a root of the first sub-tree of machine learning models and all machine learning models beneath the second machine learning model, and where each machine learning model of the first sub-tree of machine learning models can have the first common attribute.

An additional second machine learning model can be at the given hierarchical layer, a second sub-tree of machine learning models can include the additional second machine learning model being a root of the second sub-tree of machine learning models and all machine learning models beneath the additional second machine learning model, and where each machine learning model of the second sub-tree of machine learning models can have a second common attribute different from the first common attribute.

Data associated with the first sub-tree of machine learning models can be unshareable with the second sub-tree of machine learning models, and data associated with the second sub-tree of machine learning models can be unshareable with the first sub-tree of machine learning models.

The data associated with the first sub-tree of machine learning models can include at least one of model parameters of the first sub-tree of machine learning models, queries input to a machine learning model of the first sub-tree of machine learning models, outputs of the machine learning model of the first sub-tree of machine learning models, or training data used to train the machine learning model of the first sub-tree of machine learning models.

A user can be allowed to access a machine learning model of the first sub-tree of machine learning models and an additional model of the second sub-tree of machine learning models.

The first model parameters can include at least one of a model type of the first machine learning model, model weights of the first machine learning model, a loss function of the first machine learning model, or an optimization algorithm of the first machine learning model.

Model parameters associated with a machine learning model at a lower hierarchical layer can be unshareable with a machine learning model at a higher hierarchical layer.

Methods can include receiving, by the AI system, a query; obtaining, by the AI system, context data associated with the query; identifying, by the AI system based on the context data, a hierarchical layer of the hierarchical model structure; and generating, using a machine learning model at the hierarchical layer, a digital component.

The techniques described herein can be implemented to achieve the following advantages. In some cases, a user's data privacy can be protected by training a user-specific machine learning model that can be exclusively accessed by the user. In particular, model parameters of a base machine learning model can be used to generate a user-specific machine learning model. The user-specific machine learning model can be refined using user-specific training data, and data associated with the user-specific machine learning model, such as model parameters, cannot be shared with others, such as another machine learning model. By doing so, the techniques described herein can leverage an established base machine learning model to generate a user-specific machine learning model and enable the user-specific machine learning model to provide secure, customized digital component generation services to a user.

In some cases, the techniques described herein enable to generate a sector-specific machine learning model or even finer-grained sub-sector-specific machine learning model to generate sector-specific digital components. In some cases, the design style from a sector, such as the fashion industry, can be quite distinctive from another sector, such as the automobile industry. Therefore, different machine learning models may be desirable for the two different sectors. On the other hand, the machine learning models for the two different sectors can share much in common (e.g., advertisements for both the fashion industry and the automobile industry need to satisfy certain regulations). The technologies described herein enable training of a base machine learning model and using model parameters of the base machine learning model to generate at least two separate, sector-specific machine learning models (e.g., one for the fashion industry and the other for the automobile industry) for generating sector-specific digital components. By doing so, the at least two separate sector-specific machine learning models can leverage the model parameters of one common base machine learning model and generate sector-specific digital components for users from their respective sectors.

In this regard, the techniques described herein achieve significant advantages for machine learning-based digital component generation techniques. Moreover, the improved machine learning-based digital component generation techniques further result in computing and network resource efficiencies. For example, the techniques described herein reduce an amount of unsatisfactory digital components, which can utilize a significant quantity of resources stemming from generating and recommending associated results, as well as evaluating and investigating the user feedback on the unsatisfactory digital components.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for implementing digital component generations using customized machine learning models, according to an implementation of the present disclosure.

FIG. 2 is a block diagram illustrating interactions between an AI system, a generative model, and a client device, according to an implementation of the present disclosure.

FIG. 3 is a block diagram of an example system for implementing user-specific machine learning models, according to an implementation of the present disclosure.

FIG. 4 is a block diagram of an example system for implementing sector-specific machine learning models, according to an implementation of the present disclosure.

FIG. 5 is a flow chart of an example process for implementing user-specific machine learning models, according to an implementation of the present disclosure.

FIG. 6 is a flow chart of an example process for implementing sector-specific machine learning models, according to an implementation of the present disclosure.

FIG. 7 is a block diagram of an example computer system that can be used to perform described operations, according to an implementation of the present disclosure.

Like reference numbers and designations in the various drawings indicate like elements.

### DETAILED DESCRIPTION

This specification describes techniques for generating digital components using customized (e.g., user-specific or sector-specific) machine learning models and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Artificial intelligence (AI) is a segment of computer science that focuses on the creation of intelligent agents that can learn and act autonomously (e.g., without human intervention). AI can utilize machine learning, which focuses on developing algorithms that can learn from data; natural language processing, which focuses on understanding and generating human language(s); and/or computer vision, which is a field that focuses on understanding and interpreting images and videos.

In existing techniques, machine learning models can be trained to generate digital components, such as advertisements, for various users. However, some users, like VIP advertisers, may have reservations about sharing their data, such as design ideas or advertisement performance data, with others. This can lead to avoidance of leveraging machine learning models in order to protect their data from unauthorized access.

Furthermore, current technologies often train machine learning models to create digital components for different sectors, such as vertical markets or geographical regions. However, the design styles within a sector, like the fashion industry, can significantly differ from another sector, such as the automobile industry. While machine learning models can be sector-neutral and trained without specific weights assigned to any sector's training data, this can result in digital components that do not fully meet the unique needs or requirements of users from a particular sector.

In some implementations, the techniques described throughout this specification enable to generate a machine learning model specifically trained for a user or a sector and use the machine learning model to generate user-specific or sector-specific digital components. Initially, a base machine learning can be trained. The model parameters of the base machine learning model can be used to generate a user-specific or a sector-specific machine learning model which can be continuously refined using user-specific or sector-specific training data. Data associated with the user-specific or the sector-specific machine learning model can be unshareable with others to protect the data from unauthorized access. Also, due to the specific training, the user-specific or sector-specific machine learning model can generate digital components that are more satisfactory to a user who has particular needs or a user from a particular sector than those generated by the base machine learning model.

As used throughout this document, the phrase “digital component” refers to a discrete unit of digital content or digital information (e.g., a video clip, audio clip, multimedia clip, gaming content, image, text, bullet point, AI output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

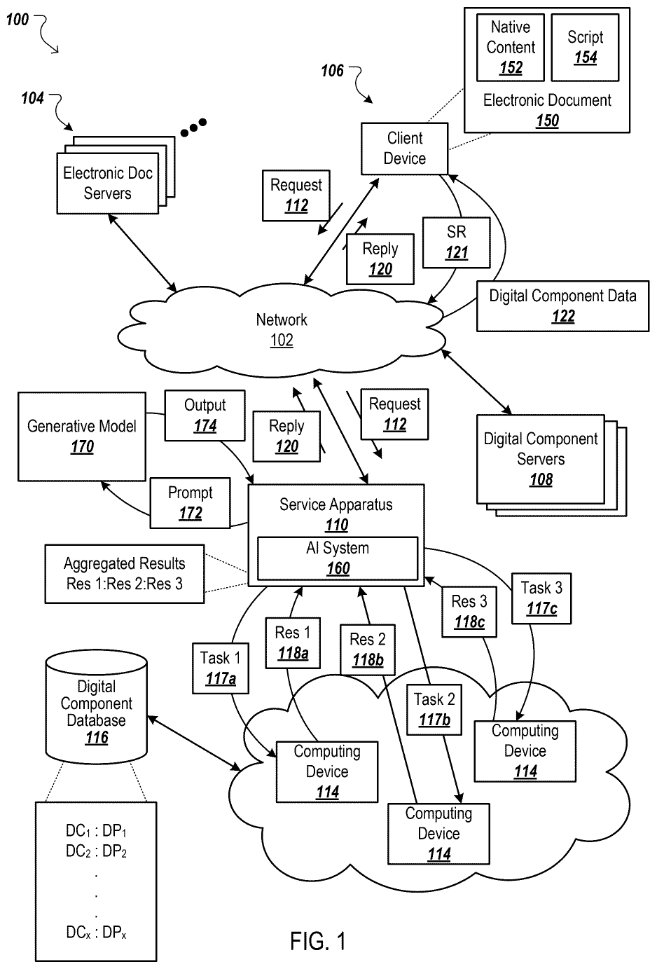

FIG. 1 is a block diagram of an example environment 100 for implementing digital component generations using customized machine learning models, according to an implementation of the present disclosure. The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic document server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., a Uniform Resource Locator (URL)) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to autonomously generate digital components, either prior to a request 112 (e.g., offline) and/or in response to a request 112 (e.g., online or real-time). As described in more detail throughout this specification, the AI system 160 can collect online content about a specific entity (e.g., digital component provider or another entity) and generate digital components based on the collected online content using one or more generative models 170.

Generative models are designed to generate new data that resembles a given training dataset and operate by learning underlying patterns, structures, and relationships present in the training dataset, enabling them to create new samples that share similar characteristics. The primary goal of generative models is to capture inherent complexity of a data distribution, allowing them to produce outputs that exhibit the same diversity and variability found in the original dataset.

One of the fundamental concepts in generative models is generation of data from random noise or latent variables. The generative models create a mapping between a latent space and data space, permitting generation of entirely novel instances that possess meaningful features. Generative models can be broadly categorized into two main types: likelihood-based and adversarial-based.

Likelihood-based generative models, such as Variational Autoencoders (VAEs) and Autoregressive Models, focus on learning the probability distribution of the data. VAEs, for instance, employ an encoder-decoder architecture to map data points into a latent space and then decode them back into the data space. This process encourages the model to learn a more structured and continuous representation of the data distribution.

Adversarial-based generative models, most notably Generative Adversarial Networks (GANs), leverage a different approach. GANs consist of two neural networks: a generator and a discriminator. The generator aims to produce data that is indistinguishable from real data, while the discriminator tries to distinguish between real and generated data. This adversarial process results in the generator improving over time and producing increasingly convincing outputs.

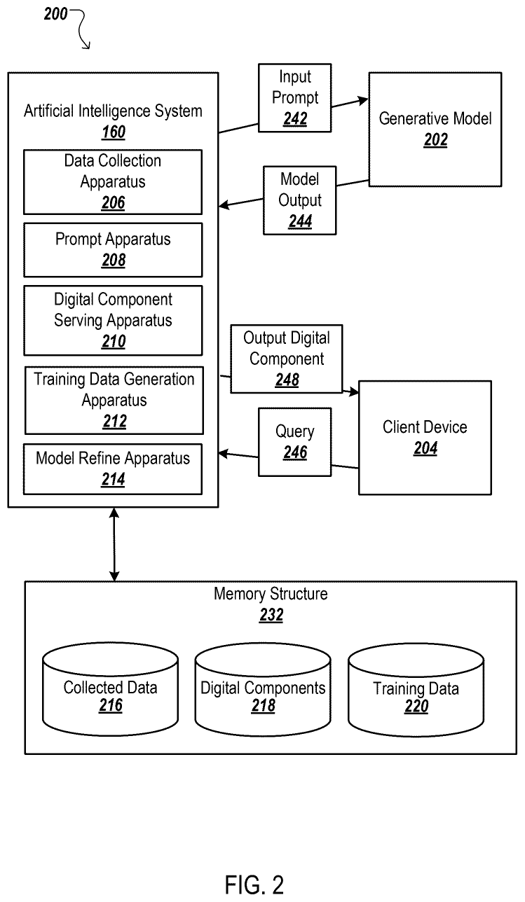

FIG. 2 is a block diagram 200 illustrating interactions between an AI system, a generative model, and a client device, according to an implementation of the present disclosure. In some situations, generative model 202 and client device 204 can, respectively, be the same or similar to the generative model 170 and client device 106 of FIG. 1. The generative model 202 can be, for example, a text-to-text generative model, a text-to-image generative model, a text-to-video generative model, an image-to-image generative model, or any other type of generative model. Although a single generative model 202 is depicted in FIG. 2, the generative model 202 can be a set of different generative models that can be invoked for different tasks for which the different generative models are specially trained. For example, one generative model within the set of generative models may be specially trained to perform content summary tasks, while another model may be specially trained to generate digital components, for example, using the output of the specially trained generative model. Furthermore, the set of models can include a generalized generative model that is larger is size, and capable of generating large amounts of diverse datasets, but this generalized model may have higher latency than the specialized models, which can make it less desirable for use in real-time operations, depending on time latency constraints required to generate content.

The AI system 160 includes a data collection apparatus 206, a prompt apparatus 208, a digital component serving apparatus 210, a training data generation apparatus 212, and a model refine apparatus 214. The following description refers to these different apparatuses as being implemented independently and each configured to perform a set of operations, but any of these apparatuses could be combined to perform the operations discussed below.

The AI system 160 is in communication with a memory structure 232. The memory structure 232, can include one or more databases. As shown, the memory structure 232 includes a collected data database 216, a digital components database 218, and a training data database 220. Each of these databases 216, 218, and 220 can be implemented in a same hardware memory device, separate hardware memory devices, and/or implemented in a distributed cloud computing environment.

At a high level, the client device 204 transmits a query 246 to the AI system 160. In some examples, a user can submit the query using a frontend interface of the AI system 160 (e.g., a website, or an application of a computing device). In some cases, the query 246 can be, for example, a request for the AI system 160 to generate a digital component (e.g., an advertisement). For example, a user can input a prompt to request the AI system 160 to generate an advertisement.

In some cases, the user can upload, to the AI system 160, one or more original digital components (e.g., images, text, and videos) associated with the query (whether as a part of the query or not), and the original digital component(s) can be used to create the digital components. For example, the original digital component(s) can be image(s) of a product, and the image(s) of the product can be included in one or more advertisements generated by the AI system 160.

In some embodiments, the user can submit additional query data to the AI system 160, where the additional query data can include data not in the query and can limit digital components generated by the AI system 160. For example, the additional query data can include but not limited to, the geographic location(s) targeted by the advertisement, a language of the advertisement, and/or a vertical industry targeted by the advertisement. For example, an advertiser can indicate that the advertisement is aimed at North American markets, should be in English language, and/or is aimed at the fashion clothing vertical industry. In some examples, the user provides the additional query data in the same prompt that requests to generate the digital component. In other examples, the additional query data is input separately from the prompt. For example, the AI system 160 can generate one or more follow-up questions in response to the user's prompt, where the one or more follow-up questions are used to solicit input of the additional query data from the user. For example, the follow-up question(s) can be “which geographic location(s) is targeted by the advertisement,” “which language should the advertisement be in,” and/or “which vertical market(s) is targeted by the advertisement?”

In some examples, the AI system 160 can collect, using the data collection apparatus 206, additional query data not input directly by the user. The data collection apparatus 206 is implemented using at least one computing device (e.g., one or more processors), and can include one or more machine learning models. In some cases, the data collection apparatus 206 can obtain an identity of an entity associated with the query. The identity can include at least one identifier, such as a company or corporation name, a URL, a telephone number, employer ID number, or other means of identifying an entity. The data collection apparatus 206 can obtain the at least one identifier using, for example, an account of the user who submitted the query or from a partner system. The data collection apparatus 206 can automatically identify, based on the identity of the entity, a data source including information about the entity. These data sources can be, but are not limited to, web pages (e.g., the entity's landing page), review compilation pages (e.g., google.com, yelp.com, and crunchbase.com), federal and/or state registries (e.g., the Delaware entity search tool), private databases, news articles, or other suitable sources. In some implementations, a data crawler application automatically queries a plurality of databases, performs searches, and extracts information from the results in response to the process being triggered. The information obtained from these data sources can be bulk text data, a combination of text and images, metadata, or other suitable data and/or media.

In some examples, the data collection apparatus 206 can perform a semantic analysis of the collected information for at least one data source. In some implementations, a single data source is analyzed using semantic analysis. In some implementations, all collected information is analyzed. The semantic analysis can be performed by one or more machine learning algorithms with an overall objective of generating one or more entity attributes associated with the entity. In some cases, the data collection apparatus 206 can perform the semantic analysis using an array of neural networks that operate in series or can include machine learning algorithms that operate in parallel, or otherwise independently of each other. In some implementations, traditional data analysis can be performed in addition to, or separately from, the machine learning processes. Similar to the additional query data, the one or more entity attributes can include, for example, the geographic location(s) targeted by the advertisement, a preferred language of the advertisement, and/or a vertical market targeted by the advertisement. In some examples, the data collection apparatus 206 can include the one or more entity attributes in the additional query data.

The data collection apparatus 206 can store the collected data in the collected data database 216. For example, the data collection apparatus 206 can index the collected data to the query used to collect the data and/or an entity characterized by the collected data so that the collected data can be retrieved from the collected data database 216 for additional operations performed by the data collection apparatus 206 and/or any operations performed by the AI system 160.

The AI system 160 can generate, using the prompt apparatus 208, an input prompt 242 using the query 246 and/or additional query data. The prompt apparatus 208 can be implemented using at least one computing device (e.g., a device including one or more processors), and can include one or more language models. In some cases, the input prompt 242 can include the query 246 and a set of constraints generated based on, for example, the additional query data. For example, the prompt apparatus 208 can insert, into the input prompt 242, one or more of the entity attribute(s) corresponding to the entity as identified by the data collection apparatus 206. In some implementations, the one or more of the entity attribute(s) inserted into the prompt operates as a contextual constraint that limits content created by the generative model 202 responsive to the input prompt 242. For example, the entity attribute(s) can limit the content created by the generative model to subject matter specified by the entity attribute(s) that is included in the prompt as a contextual constraint.

The AI system 160 can transmit the input prompt 242 to the generative model 202. The generative model 202 can then generate, based on the input prompt 242, a plurality of candidate digital components, and transmit the candidate digital components to the AI system 160 as model output 244. In some cases, the AI system 160 can receive a plurality of original digital components (e.g., original images) associated with the query. The generative model 202 can generate a plurality of candidate digital components (e.g., candidate advertisements) using the original digital components, where each of the plurality of candidate digital components includes at least one of the plurality of original digital components.

The AI system 160 can store the generated candidate digital components in the digital components database 218. For example, the AI system 160 can index the generated candidate digital components to the query used to generate the candidate digital components and/or an entity associated with the candidate digital components, so that the candidate digital components can be retrieved from the digital components database 218 for additional operations performed by the AI system 160.

For example, assume that the query 246 is “Generate an advertisement for sunglasses” and the user uploaded an image of the sunglasses. Also assume that the additional query data indicates that the entity is targeting the fashion clothing vertical market in Japan. The input prompt 242 can take the following form:

Generate a good_output: an advertisement where the query is “Generate an advertisement for sunglasses.” The good_output should target the fashion clothing vertical market in Japan.

The generative model 202 can generate multiple candidate advertisements including the image of the sunglasses and having different backgrounds. For example, an advertisement can include a Fuji Mountain scene in the background, an advertisement can include a snow scene in the background, an advertisement can include a backyard scene in the background, and an advertisement can include a Eiffel Tower scene in the background.

The AI system 160 can serve, using the digital component serving apparatus 210, one or more of the candidate digital components. The digital component serving apparatus 210 can be implemented using at least one computing device (e.g., a device including one or more processors), and can include one or more machine learning models. Assuming that the digital component is an advertisement, in some cases, the digital component serving apparatus 210 can perform advertisement rendering, including rendering and formatting the advertisement to match the publisher's website or app layout. The digital component serving apparatus 210 can generate the necessary HyperText Markup Language (HTML), images, or video components to display the advertisement. In some examples, the digital component serving apparatus 210 can perform advertisement delivery—the rendered advertisement is transmitted to the publisher's website or app, where it is displayed to the user in the designated advertisement space. In some examples, the digital component serving apparatus 210 can serve a plurality of candidate digital components generated in response to the query 246 and collect performance data of the candidate digital components. In some embodiments, the performance data can indicate acceptance levels of the candidate digital components and can be used to evaluate and rank the candidate digital components. The performance data can be based on, for example, user interactions with the candidate digital components. For example, users may interact with the advertisement by clicking on it, watching a video, purchasing a product promoted by the advertisement, or taking other actions. Examples of performance data include but not limited to, clickthrough rate (CTR), conversion rate (CVR), cost per day (CPD), and other user actions.

In some implementations, the digital component serving apparatus 210 can operate at the exploration mode or the exploitation mode. The exploration mode can be operated, for example, when the performance data needs to be collected for evaluations of the candidate digital components. When the digital component serving apparatus 210 operates at the exploration mode, the digital component serving apparatus 210 can randomly select, in each serving of a candidate digital component (e.g., in each delivery of an advertisement), one of the candidate digital components to deliver to users. After a number of deliveries, each candidate digital component has had a chance to be delivered to the users (e.g., audiences of advertisements), and the performance data of each candidate digital component has had a chance to be monitored and recorded. On the other hand, the exploitation mode can be operated, for example, when the generative model has been trained to a certain extent (e.g., when a predetermined amount of performance data has been received, when a predetermined number of training iterations has been performed, or other suitable conditions). When the digital component serving apparatus 210 operates at the exploitation mode, the digital component serving apparatus 210 does not test a plurality of candidate digital components in response to a query. Instead, a digital component generated by the digital component serving apparatus 210 can be directly delivered to users and/or the querier who requested to generate the digital component.

In some cases, by serving the candidate digital components, the AI system 160 can determine an acceptance level for each of the candidate digital components and identify a candidate digital component having a highest acceptance level (e.g., highest CTR, highest CVR, and/or highest CPD) among the candidate digital components. In some embodiments, the AI system 160 can perform identification of the candidate digital component upon the occurrence of one or more predetermined conditions, such as a predetermined period has elapsed after delivering the digital component, a candidate digital component's acceptance level has satisfied (e.g., met or exceeded) a predetermined threshold, or other suitable conditions.

The AI system 160 can determine the acceptance level in various ways. In some cases, the acceptance level is determined based on one metric of the performance data. For example, the candidate digital component having a highest CTR, highest CVR, or highest CPD has the highest acceptance level. In some cases, the performance data includes at least two different metrics, and the acceptance level is determined based on a combination of the at least two different metrics. In one example, the acceptance level can be determined based on a weighted sum of the at least two different metrics. In another example, the at least two different metrics can be ranked from a most important metric to a least important metric. First, the candidate digital components can be ranked based on the most important metric from highest to lowest. The candidate digital component ranked the highest using this metric has the highest acceptance level. For candidate digital components that are equal for at least one metric, the candidate digital components can be ranked based on a lower-ranking metric (i.e., a tiebreaker) to determine their ranking.

In some examples, the AI system 160 can identify the candidate digital component based on one or more other metrics, whether taking performance data into account or not. In some cases, a candidate digital component having the best performance data is not necessarily a desirable output. An example is a clickbait advertisement, which is an online advertisement that is designed to entice viewers to click on it. Clickbait advertisements often use intriguing or sensationalist headlines, images, or phrases to attract users' attention and encourage them to click on the advertisements to learn more. Therefore, a clickbait advertisement may excel in one metric of performance data such as CTR. If CTR is the only metric used to determine the acceptance level, a clickbait advertisement can have the highest acceptance level. However, clickbait advertisement may not be a desirable output because, for example, it can perform poorly on another metric such as CVR.

To prevent such outcome, other metric(s) can be implemented in identifying the candidate digital component. For example, candidate digital components can be ranked based on performance data from best to worst. Starting from a beginning of the ranked candidate digital components, each candidate digital component can be evaluated to determine whether an attribute(s) of the candidate digital component satisfies predetermined condition(s) (e.g., the candidate digital component does not include any clickbait advertising information). The first candidate digital component whose attribute(s) satisfies the predetermined condition(s) can be identified as the candidate digital component. In some cases, the candidate digital component can be identified based on performance data associated with the plurality of candidate digital components (e.g., using similar operations described above with respect to identifying the candidate digital component based on acceptance levels).

In some embodiments, the AI system generates, using the training data generation apparatus 212, training data. The training data generation apparatus 212 can be implemented using at least one computing device (e.g., a device including one or more processors), and can include one or more machine learning models.

In some embodiments, the generative model 202 is an unsupervised machine learning model trained using reinforcement learning algorithm(s). Reinforcement learning, also known as RL, is a machine learning approach used to solve problems by maximizing rewards or achieving specific targets through interactions between an agent and an environment, modeled as a Markov decision process (MDP). RL is an unsupervised learning method that relies on sequential feedback (e.g., rewards) from the environment. During the learning process, the agent observes the state of the environment, selects actions based on a policy, and receives feedback in the form of rewards or scores.

Through trial and error, the agent iteratively interacts with the environment, aiming to obtain a maximum reward or reach a specific target. Reward signals from the environment are used to evaluate a quality of the agent's actions rather than guiding the agent on how to perform correct actions. As the environment provides limited feedback, the agent learns through experience, acquires knowledge during interactions, and enhances an action selection policy to adapt to the environment.

More specifically, the learning process can involve the agent repeatedly observing the state of the environment, making decisions based on behavior, and receiving feedback. The objective of this learning can be to achieve an ideal state value function or policy. In some cases, the state value function can represent the expected cumulative rewards attainable by following the policy.

In one example, a state value function can be defined as:

$${V}^{π} ( s ) = {E}_{π} [ {R}_{t} \vert {s}_{t} = s ]$$

In this equation, Rₜ represents a long-term cumulative reward obtained through executing actions based on the policy π. The state value function represents an expectation of a cumulative reward brought by using the policy x starting from the state s.

As an example, assume that the digital components are images and the generative model 202 is trained to generate images based on the query and/or additional query data. The environment's state can include the following elements:
Query and/or additional query data.
Feedback on previously generated images: the feedback can be based on, for example, performance data associated with the plurality of candidate images.
   The state evolves as the generative model 202 iteratively generates images, receives feedback, and updates its policy.

The agent's action can be what the generative model 202 does in response to its current state. In this example, the agent's action can be to generate an image based on its current policy, the query and/or additional query data, and the feedback on previous generated images. The agent aims to learn a policy that leads to generating images that receive positive feedback, thus maximizing the received rewards while minimizing the penalties. The rewards and/or penalties can be determined based on a reward function.

The generative model 202's objective is to learn from these rewards and penalties to improve its digital component generation capabilities iteratively. Over time, the generative model 202 should generate digital components that are more likely to receive positive feedback, leading to better digital component generation performance. The reward function, in this case, acts as the “reinforcement signal” that guides the generative model 202's learning process.

In some implementations, when the machine learning model is an unsupervised machine learning model trained using RL algorithm(s), the AI system 160 can include, in the training data, at least one of the identified candidate digital component (e.g., pixels of a generated image), an algorithm for generating the identified candidate digital component, or a reward of the identified candidate digital component. In some cases, the training data can include other candidate digital component(s) and/or their corresponding data (e.g., other candidate digital component(s), algorithm(s) for generating the other candidate digital component(s), and/or reward(s) of the other candidate digital component(s)).

The algorithm for generating the identified candidate digital component can include, for example, one or more steps associated with generating background images for original images. In some cases, the algorithm for generating the candidate digital component can occupy a smaller memory space than the candidate digital component itself. So, in some cases, including the algorithm for generating the candidate digital component in the training data can save storage space compared to including the entire candidate digital component in the training data.

In some implementations, a reward of a candidate digital component can be generated using a reward function. To output the reward of a candidate digital component, the input(s) to the reward function can include, for example, at least one of acceptance level or performance data of the candidate digital component.

In some examples, the generative model 202 is a supervised machine learning model. The input(s) to the supervised machine learning model can include one or more features, such as an input prompt (e.g., the input prompt 242), a query (e.g., the query 246), and/or the additional query data. The output of the supervised machine learning model can be, for example, a digital component (e.g., an image). The supervised machine learning model can be trained using a set of training data and a corresponding set of labels, where the training data can include multiple sets of data relating to multiple queries and the generated digital components for the multiple queries. For example, a piece of training data can include, as feature(s) of a sample, an input prompt, a query, and/or the additional query data. The label of the piece of training data can be, for example, a digital component having high acceptance level, given the feature(s) of the sample. The machine learning model can be trained by optimizing a loss function based on a difference between the model's output during training and the corresponding label.

The training data generation apparatus 212 can store the generated training data in the training data database 220. For example, the training data database 220 can index the generated training data to the query for which the training data is generated and/or an entity associated with the generated training data, so that the generated training data can be retrieved from the training data database 220 for additional operations performed by the training data generation apparatus 212 and/or the AI system 160.

In some cases, the AI system 160 can refine, using the model refine apparatus 214, the generative model 202 using the training data. The model refine apparatus 214 can be implemented using at least one computing device (e.g., a device including one or more processors), and can include one or more machine learning models. In some cases, the model refine apparatus 214 can refine the generative model 202 immediately upon the occurrence of a particular event. For example, the generative model 202 can be re-trained when an accuracy of the generative model 202 satisfies (meets or below) a predetermined threshold. In some cases, the generative model 202 can be re-trained periodically (e.g., every seven days or thirty days) and/or re-trained when a certain amount of training data has been generated.

In some implementations, after a period of training and/or refining, the generative model 202 can satisfy one or more predetermined conditions. The one or more predetermined conditions can include, for example, an accuracy of the generative model 202 satisfies (meets or exceeds) a predetermined threshold (e.g., the CTRs of images generated by the generative model 202 satisfy predetermined threshold(s)). When the generative model 202 satisfies the one or more predetermined conditions, the AI system 160 can enter the exploitation mode where the AI system 160 can return an output digital component 248 to the client device 204 in response to a query from the client device 204.

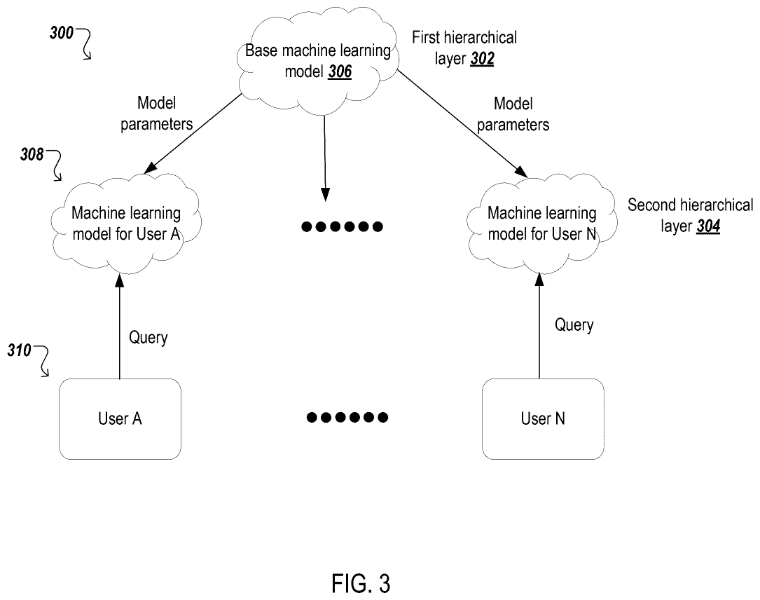

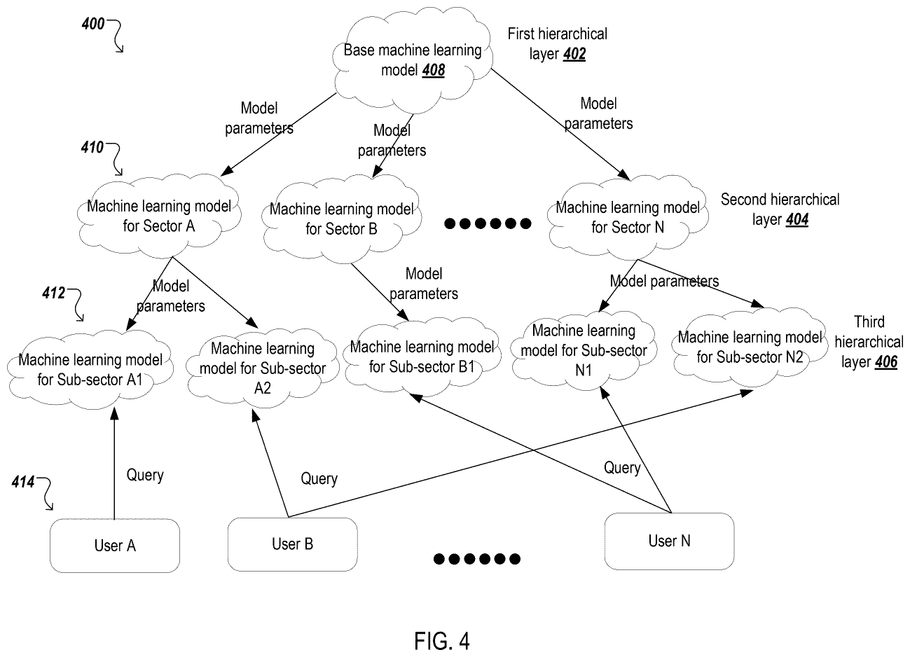

In some examples, the generative model 202 can be a machine learning model specifically trained for a user and/or a sector (e.g., the user-specific machine learning model 308 as descripted with respect to FIG. 3, the sector-specific machine learning model 410 as descripted with respect to FIG. 4, and/or the sub-sector-specific machine learning model 412 as descripted with respect to FIG. 4). In some cases, the AI system 160 can interface with more than one generative models and the AI system 160 can determine which generative model to call based on the query 246. For example, assume that there are a base machine learning model and a user-specific machine learning model. When the AI system 160 receives the query 246, the AI system 160 can determine whether a user associated with the query 246 has subscribed to a user-specific machine learning model. If the user associated with the query 246 has subscribed to a user-specific machine learning model, the AI system 160 can call the user-specific machine learning model. Otherwise, the AI system 160 can call the base machine learning model. More details are described with respect to FIGS. 3-6.

FIG. 3 is a block diagram of an example system 300 for implementing user-specific machine learning models, according to an implementation of the present disclosure. At a high level, the example system 300 is directed to a solution for generating a machine learning model specifically trained for a user and using the machine learning model to generate user-specific digital components. Initially, a base machine learning can be trained. The model parameters of the base machine learning model can be used to generate a user-specific machine learning model which can be continuously refined using user-specific training data. Due to the user-specific training, the user-specific machine learning model can generate digital components that are more satisfactory to the user than those generated by the base machine learning model. The example system 300 can be extended to even more depths using similar operations. More details are described below.

The example system 300 includes two hierarchical layers of machine learning models—a first hierarchical layer 302 and a second hierarchical layer 304 beneath the first hierarchical layer 302. The first hierarchical layer 302 includes a base machine learning model 306. The second hierarchical layer 304 can include one or more user-specific machine learning models 308 (e.g., the machine learning model for User A to the machine learning model for User N as illustrated). In some cases, each of the base machine learning model 306 and the user-specific machine learning model(s) 308 is a generative model. A user 310 (e.g., any one of User A to User N, as illustrated) can call the user-specific machine learning model(s) 308 at the second hierarchical layer 304 to generate digital components.

Initially, the base machine learning model 306 can be trained using generic training data that is sharable with the base machine learning model 306. In some cases, the base machine learning model 306 is an unsupervised machine learning model. Training the base machine learning model 306 can then be similar to the operations associated with training the unsupervised machine learning model as previously described with respect to FIG. 2, and the details are omitted here for brevity. In some cases, the base machine learning model 306 is a supervised machine learning model. Training the base machine learning model 306 can then be similar to the operations associated with training the supervised machine learning model as previously described with respect to FIG. 2, and the details are omitted here for brevity.

Model parameters of the base machine learning model 306 can be continuously updated during the training process and converge to certain value(s) after the training. In some implementations, the model parameters can include at least one of a model type of the base machine learning mode 306, model weights of the base machine learning mode 306, a loss function of the base machine learning mode 306, or an optimization algorithm of the base machine learning mode 306. The model type of the base machine learning mode 306 can be, for example, supervised, unsupervised, or other suitable model types. The model weights of the base machine learning mode 306 can include, for example, coefficient, intercept, feature weight, weight in a neural network, bias in a neural network, or other suitable model weights.

In some cases, a user can request to create a user-specific machine learning model (e.g., any one of the user-specific machine learning models 308) that can be, for example, called exclusively by the user. For example, the user can be a VIP advertiser who does not want to share data of their machine learning model with others, and thus can request a user-specific machine learning model. In some cases, creating the user-specific machine learning model 308 can include obtaining model parameters associated with the base machine learning model 306, and generating the user-specific machine learning model 308 including the model parameters associated with the base machine learning model 306. In one example, the user-specific machine learning model 308 is an exact copy of the base machine learning model 306. In another example, the user-specific machine learning model 308 can include some, but not all, of the model parameters of the base machine learning model 306.

The user-specific machine learning model 308 can be refined using user-specific training data. Examples of user-specific training data can include, but not limited to, performance data associated with digital components generated by the user-specific machine learning model 308 (e.g., performance data associated with advertisements), input prompts to the user-specific machine learning model 308, query context of the user-specific machine learning model 308, user's personalized data (e.g., user's landing page information, user's design preference, or user's background information), or other types of user-specific training data. In some implementations, the generic training data used to train the base machine learning model 306 is shareable with the user-specific machine learning model 308 and can be used to train the user-specific machine learning model 308.

In some cases, the user-specific machine learning model 308 is an unsupervised machine learning model. Refining the user-specific machine learning model 308 can then be similar to the operations associated with training the unsupervised machine learning model as previously described with respect to FIG. 2, and the details are omitted here for brevity. In some cases, the user-specific machine learning model 308 is a supervised machine learning model. Refining the user-specific machine learning model 308 can then be similar to the operations associated with training the supervised machine learning model as previously described with respect to FIG. 2, and the details are omitted here for brevity.

In some implementations, the model parameters of the user-specific machine learning model 308 can be updated after the refinement. Therefore, the model parameters of the user-specific machine learning model 308 and the model parameters of the base machine learning model 306 (which are used to generate the user-specific machine learning model 308) can have different value for at least one model parameter. In some cases, the model parameters of the user-specific machine learning model 308 are unshareable with the base machine learning model 306 and/or any other user-specific machine learning model 308. This can ensure that the base machine learning model 306 and/or any other user-specific machine learning model 308 cannot use the model parameters of the user-specific machine learning model 308 to generate a same or similar digital component which the user intends to keep private.

In some cases, the user can be provided with more than one data sharing options, each data sharing option corresponding to a respective level of data privacy. For example, the user can be provided with two data sharing options—a first data sharing option and a second data sharing option. The first data sharing option indicates that data associated with the user-specific machine learning model 308 is unshareable with others, including the base machine learning model 306 and any other user-specific machine learning model 308. The second data sharing option indicates that at least a part of the data associated with the user-specific machine learning model 308 is sharable with the base machine learning model 306 and/or other user-specific machine learning model(s) 308. The data associated with the user-specific machine learning model 308 can include at least one of model parameters associated with the user-specific machine learning model 308, queries input to the user-specific machine learning model 308, outputs of the user-specific machine learning model 308, or training data used to train the user-specific machine learning model 308. When the user selects the first data sharing option, none of the data associated with the user-specific machine learning model 308 is shareable with the base machine learning model 306 or any other user-specific machine learning model 308. This prevents the base machine learning model 306 and/or another user-specific machine learning model 308 from using the data associated with the user-specific machine learning model 308 to generate digital components.

User(s) 310 can call one or more user-specific machine learning models 308 to generate digital components. For example, the user can submit a query via an AI system (e.g., the AI system 160), and the AI system can use one or more user-specific machine learning models 308 to generate a digital component based on the query. These operations can be similar to the operations previously described with respect to FIG. 2, and the details are omitted here for brevity.

In some cases, a user can call (e.g., using a subscription) only one user-specific machine learning model 308 to generate digital components. In some cases, a user can call more than one user-specific machine learning models 308 to generate digital components. In some implementations, a user can call both base machine learning model 306 and the user-specific machine learning model(s) 308 to generate digital components.

Although two hierarchical layers are depicted in FIG. 3, the system 300 can be implemented with more than two hierarchical layers. For example, there can be a third hierarchical layer beneath the second hierarchical layer 304, and the third hierarchical layer can include one or more machine learning models. Similar to the operations with respect to machine learning model at the second hierarchical layer 304, a machine learning model at the third hierarchical layer can be generated using model parameters of a machine learning model at the second hierarchical layer 304. Data associated with the machine learning model at the third hierarchical layer may not be shared with any other machine learning model, if the user chooses not to share the data.

In some implementations, the techniques described with respect to FIG. 3 can be used in the context of generating advertisements using generative models. In one example use case, the base machine learning model 306 can be a generative model that is trained to generate advertisements using generic data that is sharable with the base machine learning model 306. Each of the users 310 can be an advertiser. In some cases, a user does not want to share their data (e.g., product information, user preferences, or trade secrets) with others, so they can request to generate a user-specific machine learning model 308. The user-specific machine learning model 308 can be trained using the user's data, and the model parameters and/or other data associated with the user-specific machine learning model 308 cannot be shared with others, including the base machine learning model 306 and any other user-specific machine learning models 308. By doing so, advertisers can leverage the generative models to create advertisements while their data can be kept private. Also, since the user-specific machine learning model 308 is trained using the user's data, the user-specific machine learning model 308 can generate digital components that will more likely satisfy the user's preferences.

FIG. 4 is a block diagram of an example system 400 for implementing sector-specific machine learning models, according to an implementation of the present disclosure. At a high level, the example system 400 is directed to a solution for generating a machine learning model specifically trained for a sector (e.g., a vertical market or a geographical region) and using the machine learning model to generate sector-specific digital components. Initially, a base machine learning can be trained. The model parameters of the base machine learning model can be used to generate a sector-specific machine learning model which can be continuously refined using sector-specific training data. Due to the sector-specific training, the sector-specific machine learning model can generate digital components that are more suitable for the sector than those generated by the base machine learning model. Using similar operations, sub-sector-specific machine learning models can be generated under the sector-specific machine learning model to generate digital components for more fine-grained sub-sectors (e.g., vertical sub-markets under a vertical market or geographical sub-regions under a geographical region). The example system 400 can be extended to even more depths using similar operations. More details are described below.

The example system 400 includes three hierarchical layers of machine learning models—a first hierarchical layer 402, a second hierarchical layer 404 beneath the first hierarchical layer 402, and a third hierarchical layer 406 beneath the second hierarchical layer 404. The first hierarchical layer 402 includes a base machine learning model 408. The second hierarchical layer 404 can include one or more sector-specific machine learning models 410 (e.g., the machine learning models for Sector A, B, and N as illustrated). The third hierarchical layer 406 can include one or more sub-sector-specific machine learning models 412 (e.g., the machine learning models for Sub-sector A1, A2, B1, N1, and N2 as illustrated). In some cases, each of the base machine learning model 408, the sector-specific machine learning model(s) 410, and the sub-sector-specific machine learning model(s) 412 is a generative model. A user 414 (e.g., any one of User A to User N as illustrated) can call the sub-sector-specific machine learning model(s) 412, the sector-specific machine learning model(s) 410, and/or the base machine learning model 408 to generate digital components. The base machine learning model 408 can be operationally and/or structurally similar to the base machine learning model 306. Likewise, the sector-specific machine learning model 410 and/or the sub-sector-specific machine learning model 412 can be operationally and/or structurally similar to the user-specific machine learning model 308.

As illustrated, all machine learning models in the example system 400 are included in a tree, where the base machine learning model 408 is the root of the tree. The tree includes multiple sub-trees, where each sector-specific machine learning model 410 is the root of a sub-tree. Each sub-sector-specific machine learning model 412 is a leaf of the tree.

The tree can be defined by defining one or more sectors and/or one or more sub-sectors. One or more sectors can be defined, with each sector representing, for example, a vertical market, a geographical region, or other suitable categorization. In one example, the sectors are defined based on vertical markets, and can include fashion, travel, automobile, and/or other suitable vertical market. In another example, the sectors are defined based on geographical regions, and can include North America, Europe, Asia, and/or other suitable geographical region.

In some cases, one or more sub-sectors can be defined under a sector, with each sub-sector representing, for example, a vertical sub-market, a geographical sub-region, or other suitable categorization. In the example of dividing sectors based on vertical markets, sub-sectors of clothes, jewelry, and/or other suitable categorization can be defined under the sector of fashion. In the other example of dividing sectors based on geographical regions, sub-sectors of United States and Canada can be defined under the sector of North America.

Training the base machine learning model 408 can be similar to the operations associated with training the base machine learning model 306 as previously described with respect to FIG. 3, and the details are omitted here for brevity. For example, the base machine learning model 408 can be sector-neutral and can be trained without assigning specific weights to the training data from any particular sector.

Similarly, generating and refining the sector-specific machine learning model 410 and/or the sub-sector-specific machine learning model 412 can be similar to the operations associated with generating and refining the user-specific machine learning model 308 as previously described with respect to FIG. 3, and the details are omitted here for brevity. For example, model parameters of the base machine learning model 408 can be used to generate a sector-specific machine learning model 410, and model parameters of the sector-specific machine learning model 410 can be used to generate a sub-sector-specific machine learning model 412. In some cases, data associated with the sector-specific machine learning model 410 cannot be shared with the base machine learning model 408. In some cases, data associated with the sub-sector-specific machine learning model 412 cannot be shared with any other machine learning model, including the base machine learning model 408, any sector-specific machine learning model 410, and any other sub-sector-specific machine learning model 412.

In some cases, the lower the machine learning model is on a hierarchical layer, the more specialized the machine learning model is in a specific sector. So, for example, the sector-specific machine learning model 410 can be more specialized than the base machine learning model 408 in generating digital components for a particular sector, and the sub-sector-specific machine learning model 412 can be more specialized than the sector-specific machine learning model 410 in generating digital components for a particular sub-sector. For example, the base machine learning model 408 can be trained to generate generic advertisements. While initialized using the model parameters of the base machine learning model 408, the sector-specific machine learning model 410 can be refined to generate advertisements for the fashion vertical market. Similarly, while initialized using the model parameters of the sector-specific machine learning model 410, the sub sector-specific machine learning model 412 can be refined to generate advertisements in a sub-sector (e.g., clothes or jewelry) under the fashion vertical market. Therefore, a machine learning model on a lower hierarchical layer can be derived from another machine learning model on a higher hierarchical layer without undue training by leveraging model parameters of the trained machine learning model on the higher hierarchical layer. Meanwhile, the machine learning model on a lower hierarchical layer can be refined to generate digital components that will more likely meet the unique needs or requirements of users from a particular sector.

User(s) 414 can call one or more sub-sector-specific machine learning models 412 to generate digital components. For example, the user can submit a query (e.g., query 246 of FIG. 2) via an AI system (e.g., the AI system 160), and the AI system can call one or more sub-sector-specific machine learning models 412 to generate a digital component based on the query. These operations can be similar to the operations previously described with respect to FIG. 2, and the details are omitted here for brevity.

In some cases, a user (e.g., User A) can call (e.g., using a subscription) only one sub-sector-specific machine learning model 412 to generate digital components. In some cases, a user (e.g., User B or User N) can call more than one sub-sector-specific machine learning models 412 to generate digital components. In some implementations, a user can call any number of the base machine learning model 408, the sector-specific machine learning model(s) 410, and/or the sub-sector-specific machine learning model(s) 412 to generate digital components.

In some implementations, an AI system (e.g., the AI system 160) can identify a machine learning model at a proper hierarchical layer for generating a digital component based on context data. For example, the AI system can identify a hierarchical layer corresponding to (e.g., most similar to) the context data and call a machine learning model of the hierarchical layer to generate the digital component. The context data can be obtained from, for example, the query, additional query data (e.g., additional query data described with respect to FIG. 2), or other suitable sources. In some cases, the AI system can perform an analysis (e.g., semantic analysis, image analysis, audio analysis, video analysis, or other suitable analysis) of the context data from at least one data source. In some implementations, context data from a single data source is analyzed. In some implementations, context data from more than one data source is analyzed. The analysis can be performed by one or more machine learning algorithms with the overall objective of identifying one or more proper hierarchical layers for generating the digital component. In some cases, the AI system can perform the analysis using an array of neural networks that operate in series or can include machine learning algorithms that operate in parallel, or otherwise independently of each other. In some implementations, traditional data analysis can be performed in addition to, or separately from, the machine learning processes.

For example, assume that the tree of machine learning models includes three hierarchical layers. The first hierarchical layer includes a base machine learning trained to generate generic advertisements. The second hierarchical layer includes a first sector-specific machine learning model trained to generate advertisements for clothing and a second sector-specific machine learning model trained to generate advertisements for sports products. Under the first sector-specific machine learning model, there can be three sub-sector-specific machine learning models trained to generate advertisements for coats, shoes, and holiday attire, respectively. Under the second sector-specific machine learning model, there can be three sub-sector-specific machine learning models trained to generate advertisements for hockey, basketball, and football, respectively. Assume that the user inputs a prompt indicating that the user wants to generate an advertisement for a product and inputs additional query data including an image of the product. The AI system can perform an image analysis on the image provided by the user and identify the object(s) included in the image. In one example, assume that the image includes a coat. The AI system can infer that the user may prefer an advertisement directed to the vertical sub-market of coats. Accordingly, the AI system can identify the sub-sector-specific machine learning model trained for coat to generate the advertisement. In another example, assume that the image includes a variety of clothing objects, such as coats, shoes, and pants. The AI system can infer that the user may prefer an advertisement directed to the vertical market of clothing. Accordingly, the AI system can identify the first sector-specific machine learning model trained for clothing to generate the advertisement.

By identifying a pre-trained machine learning model at a proper hierarchical layer for generating a digital component, the digital component generated by the identified machine learning model will more likely be accepted by the user and will likely require less post-processing in modifying the generated digital component to suit the user's needs. Accordingly, compared to generating a digital component using a generic machine learning model and modifying the generated digital component at runtime or through post-generation(s), resources can be saved by reducing post-processing.

Although three hierarchical layers are depicted in FIG. 4, the system 400 can be implemented with more than three hierarchical layers. For example, there can be a fourth hierarchical layer beneath the third hierarchical layer 406, and the fourth hierarchical layer can include one or more machine learning models (e.g., machine learning models for even finer granularity of sectors under a sub-sector). Similar to the operations with respect to machine learning model at the second or third hierarchical layer, a machine learning model at the fourth hierarchical layer can be generated using model parameters of a machine learning model at the third hierarchical layer 406. Data associated with the machine learning model at the fourth hierarchical layer may not be shared with any other machine learning model.

In some implementations, the techniques described with respect to FIG. 4 can be used in the context of generating advertisements using generative models. The base machine learning model 408 can be a generative model that is trained to generate advertisements using generic data that is sharable with the base machine learning model 408. Each of the users 414 can be an advertiser. One example use case is directed to generating advertisements for specific vertical markets. In some cases, the design style from a vertical market (e.g., the fashion industry) can be quite distinctive from another vertical market (e.g., the automobile industry). Therefore, different machine learning models may be desirable for the two different vertical markets. On the other hand, the machine learning models for the two different vertical markets can share much in common (e.g., advertisements for both the fashion industry and the automobile industry need to satisfy certain regulations). The technologies described herein enable to train a base machine learning model for generating generic advertisements, and generate at least two separate vertical market-specific machine learning models (e.g., one for the fashion industry and the other for the automobile industry) for generating vertical market-specific digital components. Moreover, similar operations can be used to generate machine learning models for vertical sub-markets that can generate advertisements more specific for their respective vertical sub-market. So, for example, clothes-specific machine learning model and jewelry-specific machine learning model can be generated using model parameters of the fashion-specific machine learning model to generate advertisements in their respective vertical sub-market.

Another example use case is directed to generating advertisements for specific geographical regions. Similar to the example use case of generating advertisements for specific vertical markets, the design style from a geographical region (e.g., North America) can be quite distinctive from another geographical region (e.g., Asia). The technologies described herein permit training a base machine learning model to generate generic advertisements and to generate at least two separate geographical region-specific machine learning models (e.g., one for North America and the other for Asia) for generating geographical region-specific digital components.

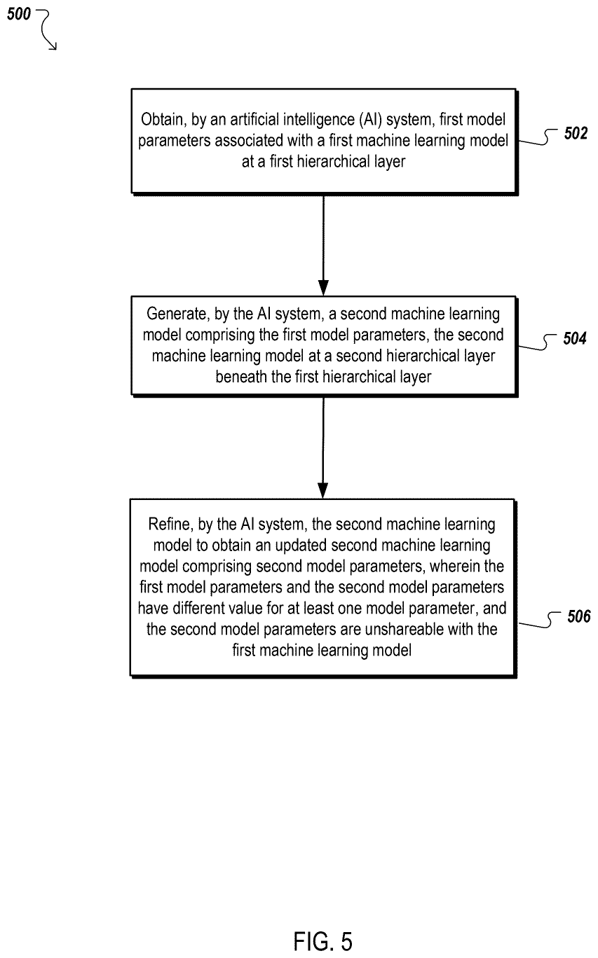

FIG. 5 is a flow chart of an example process 500 for implementing user-specific machine learning models, according to an implementation of the present disclosure. Operations of the process 500 can be performed, for example, by the service apparatus 110 of FIG. 1, or another data processing apparatus. The operations of the process 500 can also be implemented as instructions stored on a computer readable medium, which can be non-transitory. Execution of the instructions, by one or more data processing apparatus, causes the one or more data processing apparatus to perform operations of the process 500.

At 502, an AI system (e.g., the AI system 160) obtains first model parameters associated with a first machine learning model (e.g., the base machine learning model 306) at a first hierarchical layer (e.g., the first hierarchical layer 302). In some cases, the first model parameters include at least one of a model type of a machine learning model, model weights of a machine learning model, a loss function of a machine learning model, or an optimization algorithm of a machine learning model.

At 504, the AI system generates a second machine learning model (e.g., the user-specific machine learning model 308) including the first model parameters, the second machine learning model at a second hierarchical layer (e.g., the second hierarchical layer 304) beneath the first hierarchical layer. In some cases, the AI system provides a first data sharing option and a second data sharing option, where the first data sharing option indicates that data associated with the second machine learning model is unshareable with the first machine learning model, and where the second data sharing option indicates that at least a part of the data associated with the second machine learning model is sharable with the first machine learning model. In some implementations, the AI system receives an indication that the first data sharing option is selected. In some examples, the data associated with the second machine learning model includes at least one of model parameters associated with the second machine learning model, queries input to the second machine learning model, outputs of the second machine learning model, or training data used to train the second machine learning model. In some implementations, training data used to train the first machine learning model is shareable with the second machine learning model. In some cases, each of the first machine learning model and the second machine learning model is a generative model. In some implementations, a third machine learning model is at a third hierarchical layer beneath the second hierarchical layer, a fourth machine learning model is at a fourth hierarchical layer beneath the third hierarchical layer, and data associated with the third machine learning model is unshareable with the second machine learning model and is sharable with the fourth machine learning model.

At 506, the AI system refines the second machine learning model to obtain an updated second machine learning model including second model parameters, where the first model parameters and the second model parameters have different value for at least one model parameter, and the second model parameters are unshareable with the first machine learning model. In some examples, the AI system receives a query (e.g., the query 246 of FIG. 2), generates, using the second machine learning model, a digital component, and generates training data based on the digital component, where the query, the digital component, and the training data are unshareable with the first machine learning model.

In some cases, the AI system obtains additional query data (e.g., additional query data described with respect to FIG. 2) including data different from the query, where the additional query data limits digital components generated by the second machine learning model and is unshareable with the first machine learning model. The AI system generates a prompt including the query and the additional query data. The AI system inputs the prompt into the second machine learning model. The second machine learning model generates the digital component.

In some examples, the second machine learning model is a supervised machine learning model. The AI system includes the query as a feature of the training data, and includes, as a label of the training data, at least one of the digital component or an algorithm for generating the digital component.

In some examples, the second machine learning model is trained using a RL algorithm. The AI system includes, in the training data, at least one of the digital component, an algorithm for generating the digital component, or a reward of the digital component.

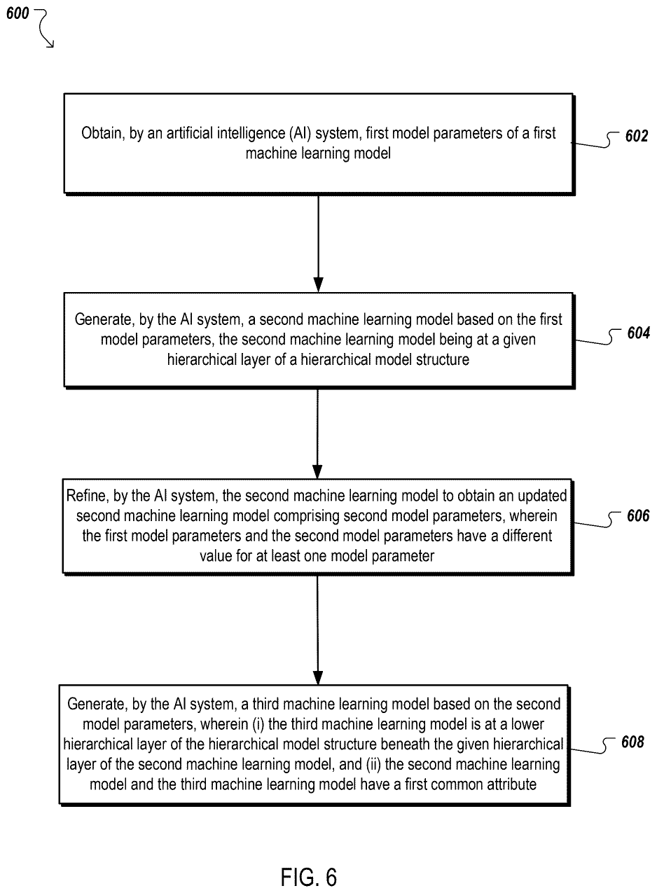

FIG. 6 is a flow chart of an example process 600 for implementing sector-specific machine learning models, according to an implementation of the present disclosure. Operations of the process 600 can be performed, for example, by the service apparatus 110 of FIG. 1, or another data processing apparatus. The operations of the process 600 can also be implemented as instructions stored on a computer readable medium, which can be non-transitory. Execution of the instructions, by one or more data processing apparatus, causes the one or more data processing apparatus to perform operations of the process 600.

At 602, an AI system obtains first model parameters of a first machine learning model (e.g., the base machine learning model 408). The first machine learning model can be at a first hierarchical layer (e.g., the first hierarchical layer 402). In some cases, the first model parameters include at least one of a model type of a machine learning model, model weights of a machine learning model, a loss function of a machine learning model, or an optimization algorithm of a machine learning model.

At 604, the AI system generates a second machine learning model (e.g., the sector-specific machine learning model 410 or the sub-sector-specific machine learning model 414) based on the first model parameters, the second machine learning model being at a given hierarchical layer (e.g., the second hierarchical layer 404 or the third hierarchical layer 406) of a hierarchical model structure.

At 606, the AI system refines the second machine learning model to obtain an updated second machine learning model including second model parameters, where the first model parameters and the second model parameters have a different value for at least one model parameter. In some cases, the second model parameters are unshareable with the first machine learning model.

At 608, the AI system generates a third machine learning model including the second model parameters, where (i) the third machine learning model is at a lower hierarchical layer of the hierarchical model structure beneath the given hierarchical layer of the second machine learning model, and (ii) the second machine learning model and the third machine learning model have a first common attribute. In some implementations, the first common attribute includes at least one of a common vertical market or a common geographical region. In some cases, the AI system refines the third machine learning model to obtain an updated third machine learning model including third model parameters, where the third model parameters and the second model parameters have at least one different model parameter, and the third model parameters are unshareable with the second machine learning model.

In some examples, the first machine learning model is a root of a tree of machine learning models, the first machine learning model has one or more machine learning models as one or more child nodes of the first machine learning model, and each child node of the first machine learning model is a root of a sub-tree, where a first sub-tree of machine learning models includes the second machine learning model being a root of the first sub-tree and all machine learning models beneath the second machine learning model, and where each machine learning model of the first sub-tree of machine learning models has the first common attribute. In some cases, an additional second machine learning model is at the given hierarchical layer, a second sub-tree of machine learning models includes the additional second machine learning model being a root of the second sub-tree and all machine learning models beneath the additional second machine learning model, and where each machine learning model of the second sub-tree of machine learning models has a second common attribute different from the first common attribute.

In some examples, data associated with the first sub-tree of machine learning models is unshareable with the second sub-tree of machine learning models, and data associated with the second sub-tree of machine learning models is unshareable with the first sub-tree of machine learning models. In some examples, data associated with the first sub-tree of machine learning models includes at least one of model parameters of the first sub-tree of machine learning models, queries input to a machine learning model of the first sub-tree of machine learning models, outputs of a machine learning model of the first sub-tree of machine learning models, or training data used to train a machine learning model of the first sub-tree of machine learning models. In some cases, a user (e.g., the user 414) is allowed to access a machine learning model of the first sub-tree of machine learning models and an additional model of the second sub-tree of machine learning models.

In some examples, the AI system can receive a query. The AI system can obtain context data associated with the query. The AI system can identify based on the context data, a hierarchical layer of the hierarchical model structure. A machine learning model at the hierarchical layer can be used to generate a digital component.

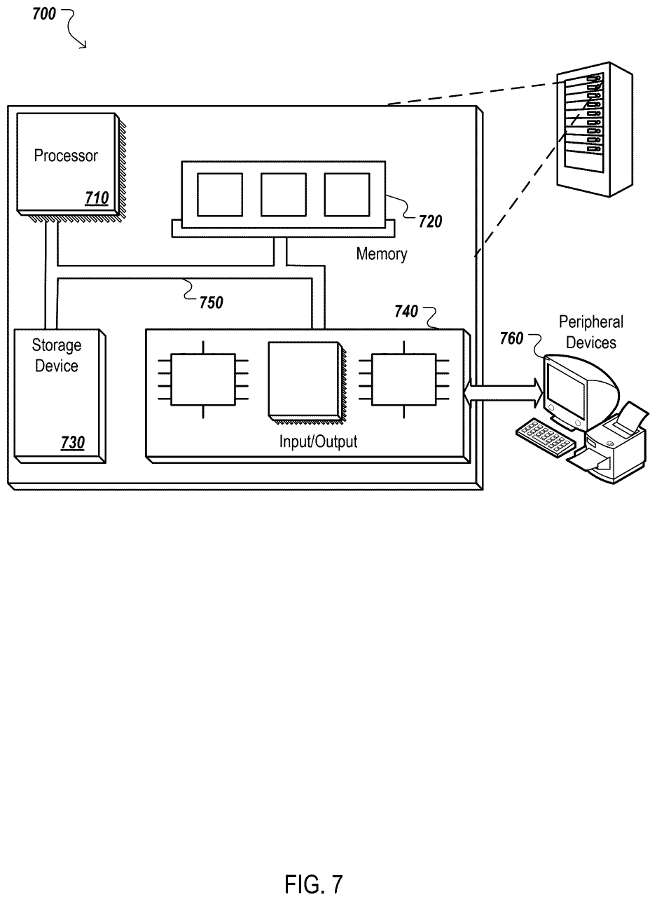

FIG. 7 is a block diagram of an example computer system 700 that can be used to perform described operations, according to an implementation of the present disclosure. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 760. Other implementations, however, can also be used, such as mobile computing devices, mobile communication devices, and set-top box television client devices.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory (RAM) or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining, by an artificial intelligence (AI) system, first model parameters of a first machine learning model;
generating, by the AI system, a second machine learning model based on the first model parameters, the second machine learning model being at a given hierarchical layer of a hierarchical model structure;
refining, by the AI system, the second machine learning model to obtain an updated second machine learning model comprising second model parameters, wherein the first model parameters and the second model parameters have a different value for at least one model parameter; and
generating, by the AI system, a third machine learning model based on the second model parameters, wherein (i) the third machine learning model is at a lower hierarchical layer of the hierarchical model structure beneath the given hierarchical layer of the second machine learning model, and (ii) the second machine learning model and the third machine learning model have a first common attribute.

2. The computer-implemented method of claim 1, wherein the first common attribute comprises at least one of a common vertical market or a common geographical region.

3. The computer-implemented method of claim 1, wherein the second model parameters are unshareable with the first machine learning model.

4. The computer-implemented method of claim 1, comprising:
refining, by the AI system, the third machine learning model to obtain an updated third machine learning model comprising third model parameters, wherein the third model parameters and the second model parameters have at least one different model parameter, and the third model parameters are unshareable with the second machine learning model.

5. The computer-implemented method of claim 1, wherein the first machine learning model is a root of a tree of machine learning models, the first machine learning model has one or more machine learning models as one or more child nodes of the first machine learning model, and each child node of the first machine learning model is a root of a sub-tree, wherein a first sub-tree of machine learning models comprises the second machine learning model being a root of the first sub-tree of machine learning models and all machine learning models beneath the second machine learning model, and wherein each machine learning model of the first sub-tree of machine learning models has the first common attribute.

6. The computer-implemented method of claim 5, wherein an additional second machine learning model is at the given hierarchical layer, a second sub-tree of machine learning models comprises the additional second machine learning model being a root of the second sub-tree of machine learning models and all machine learning models beneath the additional second machine learning model, and wherein each machine learning model of the second sub-tree of machine learning models has a second common attribute different from the first common attribute.

7. The computer-implemented method of claim 6, wherein data associated with the first sub-tree of machine learning models is unshareable with the second sub-tree of machine learning models, and data associated with the second sub-tree of machine learning models is unshareable with the first sub-tree of machine learning models.

8. The computer-implemented method of claim 7, wherein the data associated with the first sub-tree of machine learning models comprises at least one of model parameters of the first sub-tree of machine learning models, queries input to a machine learning model of the first sub-tree of machine learning models, outputs of the machine learning model of the first sub-tree of machine learning models, or training data used to train the machine learning model of the first sub-tree of machine learning models.

9. The computer-implemented method of claim 6, wherein a user is allowed to access a machine learning model of the first sub-tree of machine learning models and an additional machine learning model of the second sub-tree of machine learning models.

10. The computer-implemented method of claim 1, wherein the first model parameters comprise at least one of a model type of the first machine learning model, model weights of the first machine learning model, a loss function of the first machine learning model, or an optimization algorithm of the first machine learning model.

11. The computer-implemented method of claim 1, wherein model parameters associated with a machine learning model at a lower hierarchical layer are unshareable with a machine learning model at a higher hierarchical layer.

12. The computer-implemented method of claim 1, comprising:
receiving, by the AI system, a query;
obtaining, by the AI system, context data associated with the query;
identifying, by the AI system based on the context data, a hierarchical layer of the hierarchical model structure; and
generating, using a machine learning model at the hierarchical layer, a digital component.

13. A computer-implemented artificial intelligence (AI) system comprising:
one or more processors; and
one or more storage devices storing instructions that, when executed by the one or more processors, cause the one or more processors to perform operations comprising:
obtaining, by an artificial intelligence (AI) system, first model parameters of a first machine learning model;
generating, by the AI system, a second machine learning model based on the first model parameters, the second machine learning model being at a given hierarchical layer of a hierarchical model structure;
refining, by the AI system, the second machine learning model to obtain an updated second machine learning model comprising second model parameters, wherein the first model parameters and the second model parameters have a different value for at least one model parameter; and
generating, by the AI system, a third machine learning model based on the second model parameters, wherein (i) the third machine learning model is at a lower hierarchical layer of the hierarchical model structure beneath the given hierarchical layer of the second machine learning model, and (ii) the second machine learning model and the third machine learning model have a first common attribute.

14. The computer-implemented AI system of claim 13, wherein the first common attribute comprises at least one of a common vertical market or a common geographical region.

15. The computer-implemented AI system of claim 13, wherein the second model parameters are unshareable with the first machine learning model.

16. The computer-implemented AI system of claim 13, the operations comprising:
refining, by the AI system, the third machine learning model to obtain an updated third machine learning model comprising third model parameters, wherein the third model parameters and the second model parameters have at least one different model parameter, and the third model parameters are unshareable with the second machine learning model.

17. The computer-implemented AI system of claim 13, wherein the first machine learning model is a root of a tree of machine learning models, the first machine learning model has one or more machine learning models as one or more child nodes of the first machine learning model, and each child node of the first machine learning model is a root of a sub-tree, wherein a first sub-tree of machine learning models comprises the second machine learning model being a root of the first sub-tree of machine learning models and all machine learning models beneath the second machine learning model, and wherein each machine learning model of the first sub-tree of machine learning models has the first common attribute.

18. The computer-implemented AI system of claim 17, wherein an additional second machine learning model is at the given hierarchical layer, a second sub-tree of machine learning models comprises the additional second machine learning model being a root of the second sub-tree of machine learning models and all machine learning models beneath the additional second machine learning model, and wherein each machine learning model of the second sub-tree of machine learning models has a second common attribute different from the first common attribute.

19. The computer-implemented AI system of claim 18, wherein data associated with the first sub-tree of machine learning models is unshareable with the second sub-tree of machine learning models, and data associated with the second sub-tree of machine learning models is unshareable with the first sub-tree of machine learning models.

20. One or more non-transitory computer readable medium storing instructions, that when executed by a computer-implemented artificial intelligence (AI) system, causes the computer-implemented AI system to perform operations comprising:
obtaining, by an artificial intelligence (AI) system, first model parameters of a first machine learning model;
generating, by the AI system, a second machine learning model based on the first model parameters, the second machine learning model being at a given hierarchical layer of a hierarchical model structure;
refining, by the AI system, the second machine learning model to obtain an updated second machine learning model comprising second model parameters, wherein the first model parameters and the second model parameters have a different value for at least one model parameter; and
generating, by the AI system, a third machine learning model based on the second model parameters, wherein (i) the third machine learning model is at a lower hierarchical layer of the hierarchical model structure beneath the given hierarchical layer of the second machine learning model, and (ii) the second machine learning model and the third machine learning model have a first common attribute.
